(19) United States
(12) Patent Application Publication
(10) Pub. No.: US 2011/0265780 A1
(43) Pub. Date: Nov. 3, 2011

(54) PORTABLE GAS RANGE

(76) Inventor: Hwa Sung Ryu, Seoul (KR)

(21) Appl. No.: 13/139,350

(22) PCT Filed: Dec. 23, 2009
(86) PCT No.: PCT/KR09/07754

§ 371 Date: Jun. 13, 2011

(30) Foreign Application Priority Data
Jan. 20, 2009 (KR) 20-2009-0000668

(51) Int. Cl. A47J 37/07; F24C 3/10

(52) U.S. Cl. 126/25 B; 126/39 E

(57) ABSTRACT

The present invention relates to a portable gas range including: a case; an adjustment knob coupled rotatably to the case; a gas adjustor coupled to the case and connected to the adjustment knob to adjust an amount of gas discharged by means of the cooperative operation with the rotation of the adjustment knob; a gas cylinder attachment/detachment member adapted to support a gas cylinder in which gas is stored thereagainst and coupled to the case in such a manner as to be movable between a connection position at which the gas cylinder is connected to the gas adjustor and a connection-releasing position at which the connection state between the gas cylinder and the gas adjustor is released; a winding member coupled rotatably to the case and connected to the adjustment knob in such a manner as to be rotated by means of the cooperative operation with the rotation of the adjustment knob; and a flexible member coupled to the winding member and the gas cylinder attachment/detachment member, respectively, and made of a flexible material wound onto or unwound from the winding member by means of the cooperative operation with the rotation of the winding member to move the gas cylinder attachment/detachment member to the connection position by means of the winding or unwinding thereof.

### TECHNICAL FIELD

The present invention relates to a portable gas range, and more particularly, to a portable gas range that has a gas cylinder detachably coupled thereto so as to perform the ignition of the gas stored in the gas cylinder.

### BACKGROUND ART

A portable gas range is a gas ignition device capable of being used, while being carried or moved with ease, and recently, with the increase of outdoor activities after the introduction of five-day workweek enforcement in modern societies, the portable gas ranges become more widely used.

An example of the portable gas ranges is shown in FIG. 1. Referring to FIG. 1, the conventional portable gas range includes a case 10′, a burner 11′ coupled to the case 10′ and adapted to ignite gas injected thereinto, an adjustment knob 30′ coupled rotatably to the case 10′, and a gas adjustor 40′ to which a gas cylinder is coupled and adapted to adjust an amount of gas discharged by means of cooperative operation with the rotation of the adjustment knob 30′. Further, the case 10′ has the gas cylinder inserted thereinto and a gas cylinder seat 50′ moved linearly by means of the cooperative operation with the manipulation of a lever 3° to connect or separate the gas cylinder to or from the gas adjustor 40′. Also, if the adjustment knob 30′ is rotated in the state where the gas cylinder is connected to the gas adjustor 40′, an ignition switch 2′ works by means of a pressing protrusion 33′ formed on the adjustment knob 30′, thereby achieving the ignition on the burner 11′. As the degree of rotation of the adjustment knob 30′ is adjusted, the amount of gas supplied from the gas adjustor 40′ is controlled to adjust the strength of the flame. A reference numeral 51′ not explained yet denotes a tension coil spring adapted to return the gas cylinder seat 50′ to its original position.

By the way, according to the conventional portable gas range, the lever 3′ and the adjustment knob 30′ should be operated according to the order, which makes it inconvenient to use. So as to prevent safety accidents, moreover, the adjustment knob 30′ and the lever 3′ should be operated according to the order after the use to separate the gas cylinder from the gas adjustor 40′.

Accordingly, there is a need for the development of a portable gas range capable of achieving gas ignition by a single operation.

### DISCLOSURE

### [Technical Problem]

Accordingly, the present invention has been made in view of the above-mentioned problems occurring in the prior art, and it is an object of the present invention to provide a portable gas range that allows a gas cylinder to be connected to a gas adjustor by a single operation to achieve the ignition of the gas stored in the gas cylinder, thereby improving the convenience in use.

### [Technical Solution]

To accomplish the above object, according to the present invention, there is provided a portable gas range including: a case; an adjustment knob coupled rotatably to the case; a gas adjustor coupled to the case and connected to the adjustment knob to adjust an amount of gas discharged by means of the cooperative operation with the rotation of the adjustment knob; a gas cylinder attachment/detachment member adapted to support a gas cylinder in which gas is stored thereagainst and coupled to the case in such a manner as to be movable between a connection position at which the gas cylinder is connected to the gas adjustor and a connection-releasing position at which the connection state between the gas cylinder and the gas adjustor is released; a winding member coupled rotatably to the case and connected to the adjustment knob in such a manner as to be rotated by means of the cooperative operation with the rotation of the adjustment knob; and a flexible member coupled to the winding member and the gas cylinder attachment/detachment member, respectively, and made of a flexible material wound onto or unwound from the winding member by means of the cooperative operation with the rotation of the winding member to move the gas cylinder attachment/detachment member to the connection position by means of the winding or unwinding thereof.

### [Advantageous Effect]

According to the present invention, the portable gas range can connect or separate the gas cylinder to or from the gas adjustor by a single operation, thereby providing many conveniences in use.

Moreover, the portable gas range according to the present invention can be simplified in a structure wherein the adjustment knob and the gas cylinder attachment/detachment member are cooperatively operated with each other, thereby making it easy to be manufactured and having good durability to provide a long-term use thereof.

### DESCRIPTION OF DRAWINGS

FIG. 1 is a schematic perspective view showing a portable gas range according to the conventional practice.

FIGS. 2a and 2b are plan views showing a portable gas range according to a first embodiment of the present invention, wherein FIG. 2a shows the state where a gas cylinder is connected to a gas adjustor and FIG. 2b shows the state where the gas cylinder is separated from the gas adjustor.

FIG. 3 is a schematic separate perspective view showing the main parts in the portable gas range in FIG. 2.

FIGS. 4 and 5 are schematic sectional views showing the processes where the gas cylinder is connected to the gas adjustor.

FIG. 6 is a back perspective view showing a winding member in FIG. 3.

FIG. 7 is a front view showing the portable gas range in FIG. 2, wherein the adjustment knob is separated therefrom.

FIGS. 8 and 9 are schematic perspective views showing a portable gas range according to a second embodiment of the present invention, wherein the main parts are viewed in different directions from each other.

### BEST MODE FOR INVENTION

Hereinafter, an explanation on a portable gas range according to preferred embodiments of the present invention will be in detail given with reference to the attached drawings.

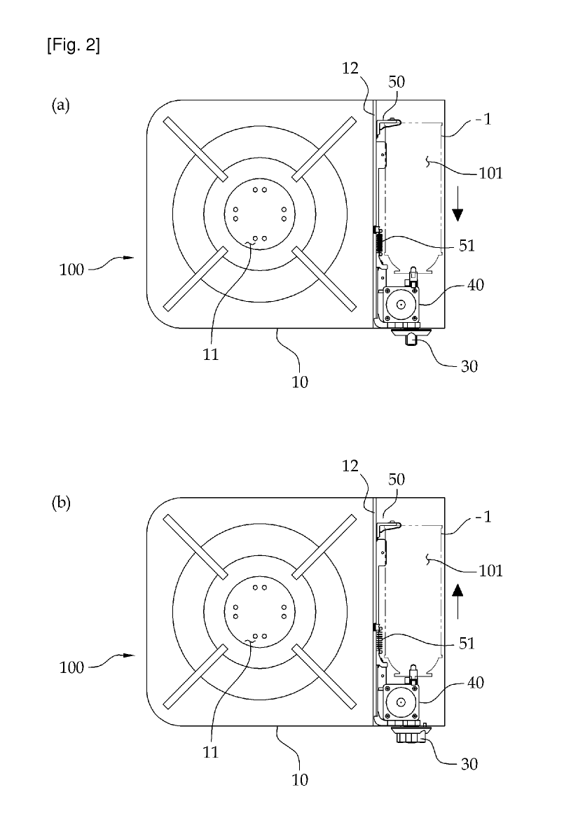

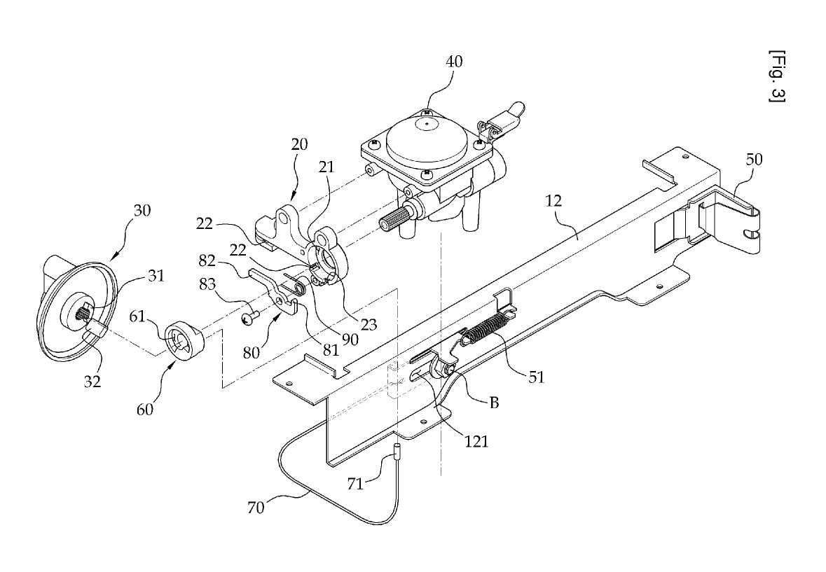

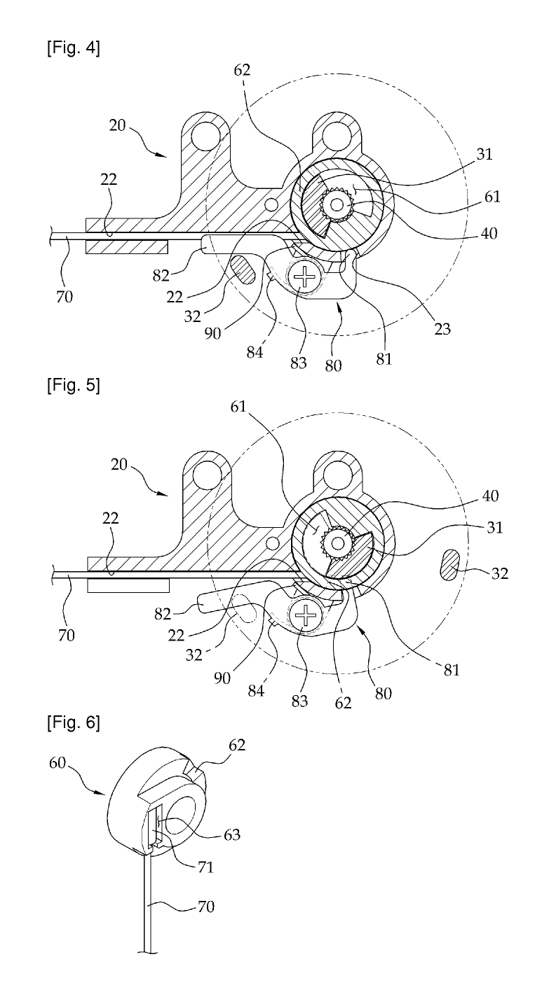

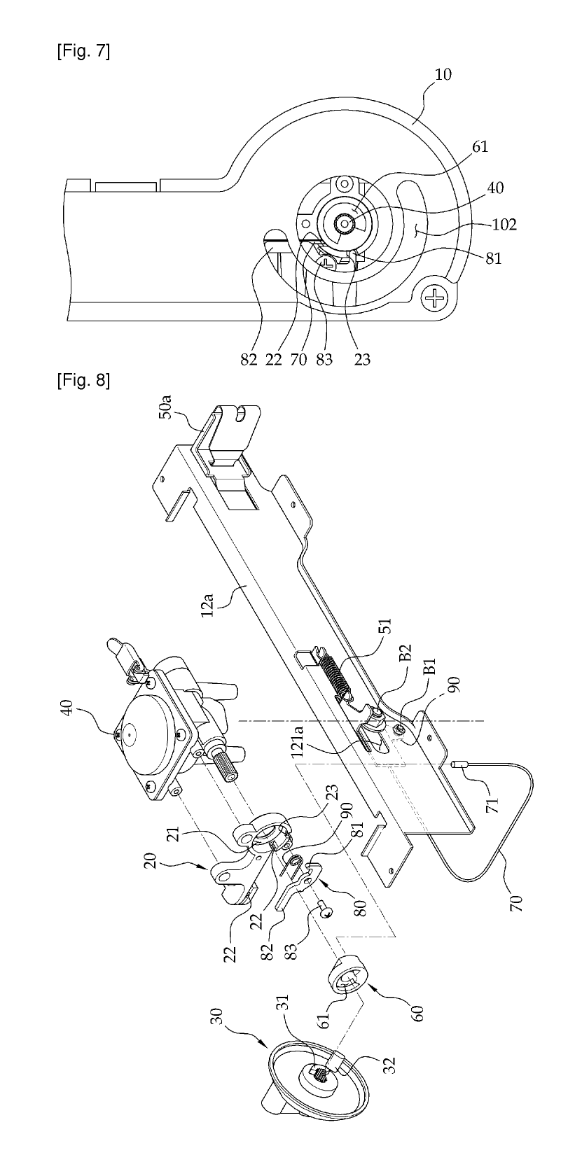

FIGS. 2a and 2b are plan views showing a portable gas range according to a first embodiment of the present invention, wherein FIG. 2a shows the state where a gas cylinder is connected to a gas adjustor and FIG. 2b shows the state where the gas cylinder is separated from the gas adjustor, FIG. 3 is a schematic separate perspective view showing the main parts in the portable gas range in FIG. 2, FIGS. 4 and 5 are schematic sectional views showing the processes where the gas cylinder is connected to the gas adjustor, FIG. 6 is a back perspective view showing a winding member in FIG. 3, and FIG. 7 is a front view showing the portable gas range in FIG. 2, wherein the adjustment knob is separated therefrom.

Referring to FIGS. 2 to 7, a portable gas range 100 according to a first embodiment of the present invention largely includes a case 10, a bracket 20, an adjustment knob 30, a gas adjustor 40, a gas cylinder attachment/detachment member 50, a winding member 60, a flexible member 70, and a locking member 80.

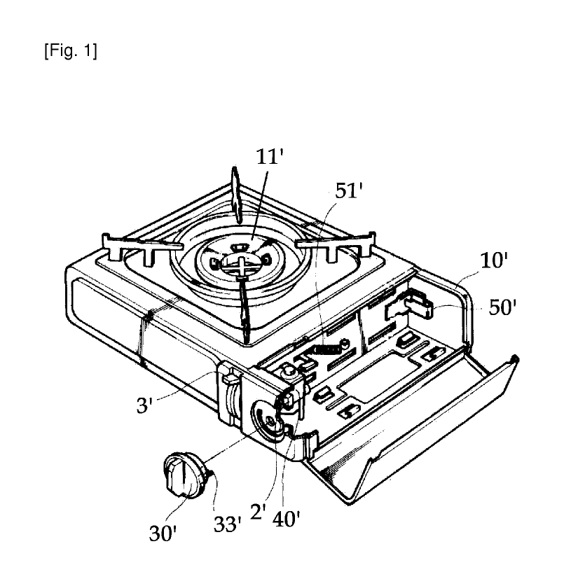

The case 10 takes a generally square shape and becomes an outer shape of the portable gas range. The case 10 is formed of a metal material. The case 10 has a burner 11 disposed therein, to which gas is injected and ignited. Also, the case 10 has a gas cylinder mounting space portion 101 formed therein, into which a gas cylinder 1 is insertedly mounted. In the meanwhile, a cover for opening and closing the gas cylinder mounting space portion 101 is not illustrated in FIG. 1. Further, the case 10 has a partition 12 formed as a unitary body therewith so as to separate the burner 11 and the gas cylinder mounting space portion 101 from each other. The partition 12 has a guide slot 121 formed thereon.

The bracket 20 is bolt-coupled to the case 10. The bracket 20 has an insertion space portion 21, first grooves 22 and a second groove 23 formed thereon.

The adjustment knob 30 is coupled rotatably to the case 10. In the same manner as the conventional practice, the adjustment knob 30 performs gas ignition on the burner 11 and the flame adjustment and at the same time performs a function as a lever, that is, a function of connecting or separating the gas cylinder 1 to or from the gas adjustor 40. Accordingly, if the adjustment knob 30 is rotated, the gas cylinder 1 inserted into the gas cylinder mounting space portion 101 is connected to the gas adjustor 40, and at the same time, an ignition switch (not shown) works to perform the gas ignition. After the use of the gas, the gas supply is blocked and at the same time the gas cylinder 1 is separated from the gas adjustor 40. On the other hand, the adjustment knob 30 has an insertion portion 31 and a pressurizing portion 32 formed thereon. The insertion portion 31 and the pressurizing portion 32 are formed spaced apart from the center shaft of the rotation of the adjustment knob 30. Further, the distance between the pressurizing portion 32 and the center shaft of the rotation of the adjustment knob 30 is longer than that between the insertion portion 31 and the center shaft of the rotation of the adjustment knob 30.

The gas adjustor 40 is coupled to the case 10. The gas adjustor 40 is directly coupled to the adjustment knob 30 in such a manner as to operate cooperatively with the rotation of the adjustment knob 30, and in accordance with the degrees of the rotation of the adjustment knob 30, an amount of gas supplied to the burner 11 is controlled.

The gas cylinder attachment/detachment member 50 is adapted to detachably couple the gas cylinder 1 to the gas adjustor 40. The gas cylinder attachment/detachment member 50 is coupled to the case 10 in such a manner as to be moved linearly in directions of arrows between a connection position as shown in FIG. 2a and a connection-releasing position as shown in FIG. 2b. At the connection position, the gas cylinder 1 supported by the gas cylinder attachment/detachment member 50 is connected to the gas adjustor 40, and thus, the gas in the gas cylinder 1 is supplied to the burner 11. On the other hand, at the connection-releasing position, the gas cylinder 1 is separated from the gas adjustor 40, and thus, the gas in the gas cylinder 1 is not supplied to the burner 11. Further, the gas cylinder attachment/detachment member 50 is elastically biased to the connection-releasing position from the connection position by means of the formation of a first elastic member 51, that is, a tension coil spring thereon. In this case, the first elastic member 51 is fixed to the partition 12 at one end thereof and to the gas cylinder attachment/detachment member 50 at the other end thereof. Also, the gas cylinder attachment/detachment member 50 has a bolt B coupled thereto, and the bolt B is inserted into the guide slot 121 of the partition 12 so as to guide the linear movement of the gas cylinder attachment/detachment member 50.

The winding member 60 is rotated in such a manner as to operate cooperatively with the rotation of the adjustment knob 30 and is rotatably inserted into the insertion space portion 21 of the bracket 20. The winding member 60 is located coaxially to the adjustment knob 30. The winding member 60 has a receiving portion 61 formed therein. The receiving portion 61 is adapted to insert the insertion portion 31 of the adjustment knob 30 thereinto. The receiving portion 61 is larger in size than the insertion portion 31, and especially, the receiving portion 61 is formed such that the insertion portion 31 is not brought into contact with the inner periphery of the receiving portion 61 within a given range of the receiving portion 61. As shown in FIGS. 4 and 5, the receiving portion 61 is formed by extending the shape of the insertion portion 31 in a circumferential direction thereof by a given distance. In the state where the adjustment knob 4 is not rotated, that is, in the state where the gas cylinder 1 is located at the connection-releasing position, as shown in FIG. 4, if the adjustment knob 30 is turned counter-clockwisely, the insertion portion 31 of the adjustment knob 30 is pressurized against the inner periphery of the receiving portion 61, such that the winding member 60 is rotated counter-clockwisely together with the adjustment knob 30. Further, in the state where the ignition is carried out on the burner 11, as shown in FIG. 5, if the adjustment knob 30 is turned clockwisely, the insertion portion 31 of the adjustment knob 30 is not pressurized against the inner periphery of the receiving portion 61 and is relatively rotated within the receiving portion 61. At the moment where the insertion portion 31 reaches a position as shown by the imaginary line of FIG. 5, the insertion portion 31 is brought into contact with the inner periphery of the receiving portion 61. In this state, if the adjustment knob 30 is further rotated, the inner periphery of the receiving portion 61 is pressured by means of the insertion portion 31, such that the adjustment knob 30 and the winding member 60 are all rotated clockwisely.

Moreover, the winding member 60 has an insertion groove 62 and an installation groove 63 formed thereon. The insertion groove 62 is formed concavedly on the outer periphery of the winding member 60, and the installation groove 63 is formed on the back surface of the winding member 60, that is, on the opposite surface to the bracket 20.

The flexible member 70 is formed of a flexible material, and according to the present invention, desirably, it is formed of a wire. The flexible member 70 is fixed at one end thereof to the gas cylinder attachment/detachment member 50 and at the other end thereof to the winding member 60. More particularly, the flexible member 70 has a fixing member 71 fixedly disposed at the other end thereof, and the fixing member 71 has a diameter larger than the flexible member 70 and is formed of a metal material. The fixing member 71 is inserted into the installation groove 63 of the winding member 60. The fixing member 71 and the installation groove 63 have roughly the same size as each other. The flexible member 70 is inserted partially into the first grooves 22 in such a manner as to be guided in movement. The flexible member 70 is wound onto or unwound from the winding member 60 as the winding member 60 is rotated. If the flexible member 70 is wound onto the winding member 60 in the state where the gas cylinder attachment/detachment member 50 is located at the connection-releasing position, the gas cylinder attachment/detachment member 50 overwhelms the elastic force of the first elastic member 51 and is located at the connection position. In this state, if the flexible member 70 is unwound from the winding member 60, the gas cylinder attachment/detachment member 50 is returned to the connection-releasing position by means of the elastic force of the first elastic member 51.

The locking member 80 is adapted to prevent the winding member 60 in the state where the gas cylinder 1 is located at the connection position from being rotated by the elastic force of the first elastic member 51, such that even though the adjustment knob 30 is not taken by a user, the gas cylinder 1 is kept at the connection position. The locking member 80 is rotatably coupled to the bracket 20 and has a locking portion 81 and a pressurized portion 82.

The locking portion 81 is formed on one end portion of the locking member 80 and is always inserted into the second groove 23 of the bracket 20, irrespective of the position of the winding member 60. The locking portion 81 is rotatable between a locking position and a locking-releasing position. If the locking portion 81 is located at the locking position, as shown in FIG. 5, the locking portion 81 is inserted into the insertion groove 62 of the winding member 60, such that the inner periphery of the insertion groove 62 is locked onto the locking portion 81, thereby preventing the rotation of the winding member 60. Accordingly, even though the adjustment knob 30 is not taken by the user in the state where the gas cylinder 1 is located at the connection position, the rotation of the winding member 60 by means of the elastic force of the first elastic member 51 can be prevented. On the other hand, the locking portion 81 is always located at the locking-releasing position, except when it is located at the locking position. For example, as shown in FIG. 4, if the gas cylinder 1 is located at the connection-releasing position, the locking portion 81 is escaped from the insertion groove 62 of the winding member 60. After the adjustment knob 30 is rotated before the locking portion 81 is located at the locking position as shown in FIG. 5 to rotate the winding member 60, if the adjustment knob 30 is not taken by the user, the winding member 60 is rotated in an opposite direction to the winding direction thereof to move the gas cylinder attachment/detachment member 50 to its original position, that is, to the connection-releasing position by means of the elastic force of the first elastic member 51.

The pressurized portion 82 is adapted to rotate the locking portion 81 from the locking position to the locking-releasing position and is formed on the other end portion of the locking member 80. The pressurized portion 82 is located on a rotation path of the pressurizing portion 32 of the adjustment knob 30 in the state where the locking member 80 is located at the locking position. If the adjustment knob is turned clockwisely in the state where the locking member 80 is located at the locking position, the pressurized portion 82 is pressurized by means of the pressurizing portion 32 of the adjustment knob 30 to rotate the locking member 80, such that the locking portion 81 is escaped from the insertion groove 62. Accordingly, the winding member 60 is rotated by means of the elastic force of the first elastic member 51, and thus, the gas cylinder attachment/detachment member 50 is returned to the connection-releasing position. Like this, the locking member 80 is connected to the adjustment knob 30, and when the adjustment knob 30 is rotated, the locking member 80 is moved from the locking position to the locking-releasing position. Further, as shown in FIG. 7, a slot 102 is penetrated along the rotation path of the pressurized portion 82 on the front surface of the case 10.

Moreover, a pivot shaft 83 of the locking member 80 is disposed between the locking portion 81 and the pressurized portion 82, and the pivot shaft 83 is coupled to the locking member 80 and the bracket 20. The locking member 80 is rotated around the pivot shaft 83, and the center shaft of the rotation of the locking member 80 is formed in parallel to the center shaft of the rotation of the adjustment knob 30. In this case, the pivot shaft 83 is composed of a bolt.

Also, the locking member 80 is elastically biased to a direction where the locking portion 81 is inserted into the insertion groove 62 by means of a second elastic member 90. The second elastic member 90 is composed of a torsion spring and is supportedly contacted with the bracket 20 at one end portion thereof and with a locking protrusion 84 of the locking member 80 at the other end portion thereof. The locking member 80 is always kept contacted with the outer periphery of the winding member 60 by means of the elastic force of the second elastic member 90 in the state of being located at the locking-releasing position, and the locking member 80 is rotated by means of the elastic force of the second elastic member 90, thereby being located at the locking position.

According to the portable gas range 100 of the present invention as mentioned above, if the adjustment knob 30 is rotated counter-clockwisely after the gas cylinder 1 has been inserted into the gas cylinder mounting space portion 101, the winding member 60 is rotated counter-clockwisely. If the winding member 60 is rotated, the gas cylinder attachment/detachment member 50 is moved toward the gas adjustor 40, and as shown in FIG. 5, at the moment when the locking portion 81 of the locking member 80 is inserted into the insertion groove 62 of the winding member 60, the gas cylinder 1 is connected to the gas adjustor 40. At the same time, the ignition switch is struck by the adjustment knob 30 and is thus operated. At this time, the gas adjustor 40 discharges a maximum amount of gas therefrom, and thus, the ignition is achieved on the burner 11. Also, even if the adjustment knob 30 is not taken by the user in the state where the ignition is achieved, the state where the locking portion 81 is inserted into the insertion groove 62 is kept such that the winding member 60 is not rotated to allow the connection state of the gas cylinder 1 to be continuously maintained.

In the meanwhile, so as to separate the gas cylinder 1 from the gas adjustor 40, the adjustment knob 30 is just rotated clockwisely in the state as shown in FIG. 5, and thus, since the pressurizing portion 32 of the adjustment knob 30 pressurizes the pressurized portion 82 of the locking member 80 before the insertion portion 31 of the adjustment knob 30 is located at the position as shown by the imaginary line of FIG. 5, the locking member 80 is rotated, such that the locking portion 81 of the locking member 80 is escaped from the insertion groove 62 of the winding member 60. At this moment, the winding member 60 is rotated by means of the elastic force of the first elastic member 51, and thus, the gas cylinder attachment/detachment member 50 is moved to the connection-releasing position. Accordingly, the gas cylinder 1 is easily separated from the gas adjustor 40.

According to the preferred embodiment of the present invention, only if the adjustment knob 30 is rotated, the gas cylinder 1 can be connected to or separated from the gas adjustor 40, thereby providing many conveniences in the use of the portable gas range. Moreover, the gas cylinder 1 can be separated naturally from the gas adjustor 40, thereby basically preventing the safety accidents caused by leaving the gas cylinder 1 in the state of being connected to the gas adjustor 40.

Furthermore, the parts that allow the adjustment knob 30 and the gas cylinder attachment/detachment member 50 to be operated cooperatively with each other, that is, the winding member 60, the first elastic member 51, the flexible member 70, the locking member 80, and the second elastic member 90 are coupled with simple configurations, thereby making it easy to be manufactured and having good durability to provide a long-term use thereof.

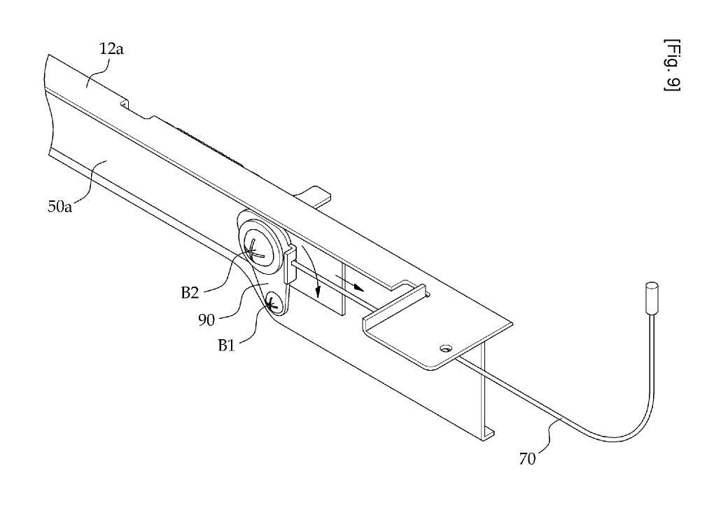

On the other hand, the gas cylinder attachment/detachment member in the first embodiment of the present invention is configured to be linearly moved, but as shown in FIGS. 8 and 9, it may be configured to be rotatably moved. For the brevity of the drawings, the illustration of the unnecessary parts is avoided in FIG. 8.

Referring to FIGS. 8 and 9, according to a second embodiment of the present invention, a gas cylinder attachment/detachment member 50a is coupled to a connection member 91. The connection member 91 is bolt-coupled to a partition 12a and is rotatable with respect to the partition 12a around a bolt B1. Also, the connection member 91 is bolt-coupled to the gas cylinder attachment/detachment member 50a, and thus, the gas cylinder attachment/detachment member 50a is moved together with the connection member 91. Especially, the partition 12a has a through-hole 121a formed thereon, into which a bolt B2 adapted to couple the gas cylinder attachment/detachment member 50a to the connection member 91 is inserted and guided in rotation without any interference during the rotation of the connection member 91. That is, the during the rotation of the connection member 91, the shank of the bolt B2 is brought into contact with the inner periphery of the through-hole 121a and is guided in rotation, so that the rotation of the bolt B2 is not interfered.

Further, a flexible member 70 is fixed to the gas cylinder attachment/detachment member 50a or the connection member 91, and according to the second embodiment of the present invention, desirably, it is fixed to the connection member 91. Also, the flexible member 70 is desirably coupled to a portion of the connection member 91 far distant from the portion to which the bolt B1 is coupled. In this case, upon the rotation of the connection member 91, the moment of the connection member 91 being rotated around the bolt B1 can be stronger, so that the gas cylinder attachment/detachment member 50a can be easily moved.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A portable gas range comprising:
a case;
an adjustment knob coupled rotatably to the case;
a gas adjustor coupled to the case and connected to the adjustment knob to adjust an amount of gas discharged by means of the cooperative operation with the rotation of the adjustment knob;
a gas cylinder attachment/detachment member adapted to support a gas cylinder in which gas is stored thereagainst and coupled to the case in such a manner as to be movable between a connection position at which the gas cylinder is connected to the gas adjustor and a connection-releasing position at which the connection state between the gas cylinder and the gas adjustor is released;
a winding member coupled rotatably to the case and connected to the adjustment knob in such a manner as to be rotated by means of the cooperative operation with the rotation of the adjustment knob; and
a flexible member coupled to the winding member and the gas cylinder attachment/detachment member, respectively, and made of a flexible material wound onto or unwound from the winding member by means of the cooperative operation with the rotation of the winding member to move the gas cylinder attachment/detachment member to the connection position by means of the winding or unwinding thereof.

2. The portable gas range according to claim 1, further comprising: a first elastic member adapted to elastically bias the gas cylinder attachment/detachment member to allow the gas cylinder attachment/detachment member to move from the connection position to the connection-releasing position; a locking member coupled to the case in such a manner as to be moved between a locking position at which the locking to the winding member is formed to prevent the rotation of the winding member and a locking-releasing position at which the locking to the winding member is released to move the gas cylinder attachment/detachment member to the connection-releasing position; and a second elastic member adapted to elastically bias the locking member to allow the locking member to be brought into contact with the winding member to move the locking member to the locking position from the locking-releasing position.

3. The portable gas range according to claim 2, wherein the locking member is connected to the adjustment knob in such a manner as to be moved from the locking position to the locking-releasing position by means of the cooperative operation with the rotation of the adjustment knob.

4. The portable gas range according to claim 3, wherein the locking member is coupled rotatably to the case in such a manner where one of the locking member and the winding member has a locking portion formed thereon, while the other having an insertion groove into which the locking portion is inserted and where one of the locking member and the adjustment knob has a pressurizing portion disposed spaced apart from the center shaft of the rotation of the adjustment knob, while the other having a pressurized portion adapted to be pressurized by means of the pressurizing portion to allow the locking member to be rotated to the locking-releasing position upon the rotation of the adjustment knob.

5. The portable gas range according to claim 2, wherein the gas cylinder attachment/detachment member is movable linearly between the connection position and the connection-releasing position.

6. The portable gas range according to claim 5, wherein the flexible member is formed of a wire, and the case further has a bracket coupled thereto, the bracket having an insertion space portion into which the winding member is inserted rotatably, first grooves into which the flexible member is inserted, and a second groove into which the locking member is inserted.

7. The portable gas range according to claim 4, wherein the flexible member is formed of a wire, and the case further has a bracket coupled thereto, the bracket having an insertion space portion into which the winding member is inserted rotatably, first grooves into which the flexible member is inserted, and a second groove into which the locking member is inserted.

8. The portable gas range according to claim 3, wherein the flexible member is formed of a wire, and the case further has a bracket coupled thereto, the bracket having an insertion space portion into which the winding member is inserted rotatably, first grooves into which the flexible member is inserted, and a second groove into which the locking member is inserted.
